(19) United States
(12) Patent Application Publication
(10) Pub. No.: US 2019/0228767 A1
(43) Pub. Date: Jul. 25, 2019

(54) SPEECH RECOGNITION APPARATUS AND METHOD OF CONTROLLING THE SAME

(71) Applicants: Hyundai Motor Company, Seoul (KR); Kia Motors Corporation, Seoul (KR)

(72) Inventors: Seona KIM, Seoul (KR); Jeong-Eom LEE, Yongin-si (KR); Dongsoo SHIN, Suwon-si (KR)

(73) Assignees: Hyundai Motor Company, Seoul (KR); Kia Motors Corporation, Seoul (KR)

(21) Appl. No.: 15/968,044

(22) Filed: May 1, 2018

(30) Foreign Application Priority Data
Jan. 19, 2018 (KR) 10-2018-0007201

(51) Int. Cl. G10L 15/22; G10L 15/02; G10L 15/30

(52) U.S. Cl. CPC G10L 15/22; G10L 15/02; G10L 2015/223; G10L 2015/025; G10L 15/30

(57) ABSTRACT

A speech recognition apparatus may include a speech input device configured to receive input of a speech of a user; a database configured to store instruction codes used to generate an instruction; a controller configured to convert the speech into speech data, analyze a sentence uttered by the user comprised in the speech data after a predetermined waiting time, generate an instruction corresponding to an analyzed uttered sentence, and determine whether the uttered sentence may include a target of control and a control command; an output device configured to output the analyzed uttered sentence and a response message to the instruction; and a drive device configured to operate the target of control in accordance with the instruction.

### CROSS-REFERENCE TO RELATED APPLICATION(S)

The present application claims priority to Korean Patent Application No. 10-2018-0007201, filed on Jan. 19, 2018, the entire contents of which is incorporated herein for all purposes by this reference.

### BACKGROUND OF THE INVENTION

### Field of the Invention

The present invention relates to a speech recognition apparatus configured to operate a function of a vehicle by speech recognition as desired by a user by analyzing a sentence uttered by the user using a first waiting time and a second waiting time and a method of controlling the speech recognition apparatus.

### Description of Related Art

In a speech recognition system that recognizes an utterance of a user and operates a function of a vehicle, it is important how a user's utterance is received. Since speaking speeds vary from person to person, there is a need to accurately determine time at which an utterance ends.

A conventional speech recognition apparatus waits for a predetermined waiting time and then analyzes an utterance and responds to the utterance unless an additional utterance is input during the waiting time. In the case where a user speaks relatively slowly, the conventional speech recognition apparatus analyzes an utterance immediately after the predetermined waiting time even when the utterance is not finished. In the instant case, a function of a vehicle is activated based on an incomplete utterance causing malfunctioning.

That is, conventional speech recognition apparatuses often malfunction due to attempts to operate functions of vehicles in a state where the intention of the user is not accurately recognized.

Furthermore, in the case where a speech recognition system waits for a long time period to receive an utterance of the user, the speech recognition system slowly outputs a response even after the utterance is actually over and thus the user may feel uneasy and performance of the system may deteriorate.

Therefore, there is a need to develop techniques of outputting a quick response and reducing malfunctions by adjusting a waiting time for inputting an utterance of the user and performing real-time analysis of the utterance.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a speech recognition apparatus configured for inputting a complete utterance by adjusting a waiting time for input of a user's utterance even when a user's speaking speed is relatively low and a method of controlling the speech recognition apparatus.

According to the speech recognition apparatus and the method of controlling the same, malfunctions may be reduced and quicker responses may be output by setting a first waiting time and a second waiting time, determining whether or not an instruction is completed by analyzing an utterance after the first waiting time, and generating a response in accordance with a determination result or waiting for an additional utterance input during the second waiting time.

Various aspects of the present invention are directed to providing a speech recognition apparatus configured for generating an inquiry fitting an intention of a user via generation of an inquiry about a predicted utterance based on a current state of a vehicle and operating a target of control as desired by the user and a method of controlling the same.

Additional aspects of the disclosure will be set forth in part in the description which follows and, in part, will be obvious from the description, or may be learned by practice of the disclosure.

According to various aspects of the present invention, there is provided a speech recognition apparatus including: a speech input device configured to receive input of a speech of a user; a database configured to store instruction codes used to generate an instruction; a controller configured to convert the speech into speech data, analyze a sentence uttered by the user comprised in the speech data after a predetermined waiting time, generate an instruction corresponding to an analyzed uttered sentence, and determine whether or not the uttered sentence may include a target of control and a control command; an output device configured to output the analyzed uttered sentence and a response message to the instruction; and a drive device configured to operate the target of control in accordance with the instruction.

When an additional speech is not input during a first waiting time, the controller may analyze a first uttered sentence comprised in the speech data and generates an instruction corresponding to the first uttered sentence with reference to the database.

When the first uttered sentence may include both the target of control and the control command, the controller may be configured to determine that the instruction is completed and transmits the instruction to the drive device.

When the first uttered sentence does not include one or more of the target of control and the control command, the controller may receive input of an additional speech during a second waiting time.

When the additional speech is input during the second waiting time, the controller may re-analyze the entire uttered sentence including the first uttered sentence and a second uttered sentence comprised in additional speech data after a time corresponding to the first waiting time elapses.

When the additional speech is not input during the second waiting time, the controller may be configured to generate an inquiry about a predicted utterance based on the first uttered sentence and a current state of a vehicle.

The controller may analyze a sentence uttered by the user in a response to the inquiry about the predicted utterance, generates an instruction corresponding to an analyzed uttered sentence, and transmits the instruction to the drive device.

The controller may separate the uttered sentence into morphemes and words, extracts a target of control and a control command from the uttered sentence separated into morphemes and words, and generates the instruction by combining a target code corresponding to the target of control and a control command code corresponding to the control command.

The database may include a target code corresponding to the target of control, a control command code corresponding to the control command, a response message to the instruction, and an inquiry about a predicted utterance.

According to various aspects of the present invention, a method of controlling a speech recognition apparatus, the method including: receiving input of a speech of a user; generating an instruction by converting the speech into speech data, and analyzing a sentence uttered by the user comprised in the speech data after a predetermined waiting time; determining whether or not the uttered sentence may include a target of control and a control command; outputting the analyzed uttered sentence and a response message in accordance with the instruction; and operating the target of control according to the instruction.

The generating of the instruction may further comprise: analyzing a first uttered sentence comprised in the speech data when an additional speech is not input during a first waiting time; and generating an instruction corresponding to the first uttered sentence with reference to a database.

The operating of the target of control may be performed by operating the target of control in accordance with the instruction when the first uttered sentence may include both the target of control and the control command.

The receiving of input of a speech of a user may further include receiving input of an additional speech during a second waiting time when the first uttered sentence does not include one or more of the target of control and the control command.

The generating of the instruction may further include re-analyzing the entire uttered sentence including the first uttered sentence and a second uttered sentence comprised in additional speech data after a time corresponding to the first waiting time elapses when the additional speech is input during the second waiting time.

The generating of the instruction may further include generating an inquiry about a predicted utterance based on the first uttered sentence and a current state of a vehicle when the additional speech is not input during the second waiting time.

The generating of the instruction may further include analyzing a sentence uttered by the user in a response to the inquiry about the predicted utterance and generating an instruction corresponding to the analyzed uttered sentence.

The generating of the instruction may be performed by separating the uttered sentence into morphemes and words, extracting a target of control and a control command from the uttered sentence separated into morphemes and words, and generating an instruction by combining a target code corresponding to the target of control and a control command code corresponding to the control command.

The database may include a target code corresponding to the target of control, a control command code corresponding to the control command, a response message to the instruction, and an inquiry about a predicted utterance.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is an external view of a vehicle according to an exemplary embodiment of the present invention.

FIG. 2 is an internal view of a vehicle according to an exemplary embodiment of the present invention.

FIG. 3 is a control block diagram of the speech recognition apparatus.

FIG. 4 is a diagram for describing a method of generating an instruction by analyzing an uttered sentence, the analyzing performed by a speech recognition apparatus according to an exemplary embodiment of the present invention.

FIG. 5 is a flowchart of a method of controlling a speech recognition apparatus according to an exemplary embodiment of the present invention.

FIG. 6, FIG. 7, FIG. 8, and FIG. 9 are diagrams exemplarily illustrating output of response messages performed by the speech recognition apparatus 100 according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments of the present invention, it will be understood that the present description is not intended to limit the invention(s) to those exemplary embodiments. On the contrary, the invention(s) is/are intended to cover not only the exemplary embodiments of the present invention, but also various alternatives, modifications, equivalents and other embodiments, which may be included within the spirit and scope of the invention as defined by the appended claims.

Reference will now be made more specifically to the exemplary embodiments of the present invention, examples of which are illustrated in the accompanying drawings, wherein like reference numerals refer to like elements throughout. The present specification does not describe all elements of the exemplary embodiments of the present invention and detailed descriptions on what are well-known in the art or redundant descriptions on substantially the same configurations may be omitted. The terms ‘unit’, ‘module’, ‘member’, or ‘block’ used in the specification may be implemented using a software or hardware component. According to an exemplary embodiment of the present invention, a plurality of ‘units’, ‘modules’, ‘members’, or ‘blocks’ may also be implemented using an element and one ‘unit’, ‘module’, ‘member’, or ‘block’ may include a plurality of elements.

Throughout the specification, when an element is referred to as being ‘connected to’ another element, it may be directly or indirectly connected to the other element and the ‘indirectly connected to’ includes connected to the other element via a wireless communication network.

Also, it is to be understood that the terms ‘include’ or ‘have’ are intended to indicate the existence of elements included in the specification, and are not intended to preclude the possibility that one or more other elements may exist or may be added.

The terms ‘first’, ‘second’ etc. are used to distinguish one component from other components and, therefore, the components are not limited by the terms.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, operating principles and embodiments of the present invention will be described with reference to the accompanying drawings.

Reference will now be made more specifically to the exemplary embodiments of the present invention, examples of which are illustrated in the accompanying drawings, wherein like reference numerals refer to like elements throughout.

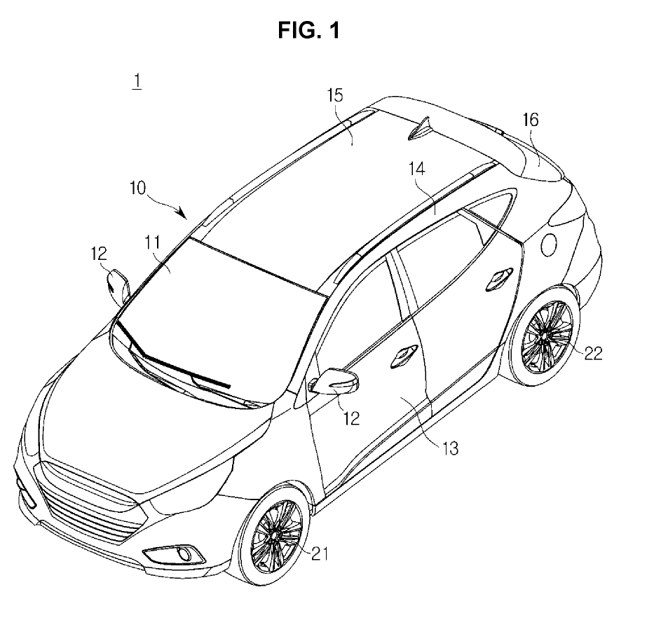

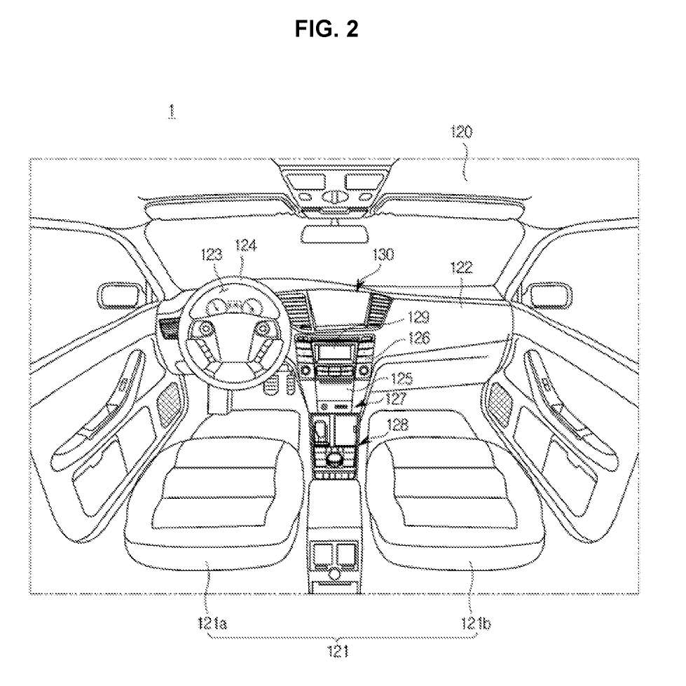

FIG. 1 is an external view of a vehicle according to an exemplary embodiment of the present invention. FIG. 2 is an internal view of a vehicle according to an exemplary embodiment of the present invention.

Referring to FIG. 1, the external of a vehicle 1 includes a body 10 configured to define an appearance of the vehicle 1, a windscreen 11 configured to provide a driver with views in front of the vehicle 1, side mirrors 12 configured to provide the driver with views behind the vehicle 1, doors 13 configured to shield the inside of the vehicle 1 from the outside, and front wheels 21 disposed at front portions of the vehicle 1 and rear wheels 22 disposed at rear portions of the vehicle 1. The front wheels 21 and the rear wheels 22 may collectively be referred to as wheels.

The windscreen 11 is disposed at a front upper portion of the body 10 to allow the driver in the vehicle 1 to acquire visual information related to a view in front of the vehicle 1. Also, the side mirrors 12 include a left side mirror disposed at the left side of the body 10 and a right side mirror disposed at the right side of the body 10 and allow the driver in the vehicle 1 to acquire visual information related to areas beside and behind the vehicle 1.

The doors 13 are pivotally coupled to left and right sides of the body to allow the driver to get into the vehicle 1 by opening the door and the internal to the vehicle 1 may be shielded from the outside thereof by closing the doors.

Referring to FIG. 2, the internal 120 of the body includes seats 121 (121a and 121b) on which a driver and passengers sit, a dashboard 122, an instrument cluster 123 disposed on the dashboard 122 and provided with a tachometer, a speedometer, a coolant thermometer, a fuel gauge, an indicator light for direction change, a high beam indicator light, a warning light, a seat belt warning light, a trip meter, an odometer, an automatic transmission selection indicator light, a door open warning light, an engine oil warning light, and a low fuel warning light, a steering wheel 124 configured to control a direction of the vehicle 1, and a center fascia 125 provided with a control panel of an audio device and an air conditioner.

The seats 121 include a driver's seat 121a, a front passenger's seat 121b, and back seats located at the rear of the vehicle 1.

The instrument cluster 123 may be implemented as a digital type. Such a digital type instrument cluster displays information related to the vehicle 1 and driving-related information as images.

The center fascia 125 is located at the dashboard 122 between the driver's seat 121a and the front passenger's seat 121b and includes a head device 126 configured to control the audio device, the air conditioner, and heating wires of the seats 121.

In this regard, the head device 126 may include a plurality of buttons to input commands to operate the audio device, the air conditioner, and the heating wires of the seats 121.

The center fascia 125 may be provided with vents, a cigar jack, a multi-port 127, and the like.

In the instant case, the multi-port 127 may be disposed adjacent to the head device 126 and may further include a USB port, an AUX port, and an SD slot.

The vehicle 1 may further include an input device 128 configured to receive input of commands to operate various functions and a display device 129 configured to display information on functions being performed and information input by the user.

The display device 129 may include a display panel including a light emitting diode (LED) panel, an organic light emitting diode (OLED) panel, or a liquid crystal display (LCD) panel.

The input device 128 may be provided at the head device 126 and the center fascia 125 and include at least one physical button including On/Off buttons to operate various functions and buttons to change settings of the various functions.

The input device 128 may transmit manipulation signals of the buttons to an electronic control unit (ECU), a controller 400 of the head device 126, or an AVN device 130.

The input device 128 may include a touch panel integrated with a display device of the AVN device 130. The input device 128 may be displayed on the display device of the AVN device 130 and activated in a button form and receive location information on the displayed button.

The input device 128 may further include a jog dial or a touch pad to input a command to move a cursor displayed on the display device of the AVN device 130 and a command to select the function. In this regard, the jog dial or the touch pad may be provided at the center fascia.

The input device 128 may receive one of a manual mode in which the driver runs the vehicle 1 and an autonomous driving mode. When the autonomous driving mode is input, the input device 128 transmits an input signal of the autonomous driving mode to the controller 400.

The controller 400 may not only distribute signals to devices disposed in the vehicle 1 but also transmit signals with regard to commands to control the devices of the vehicle 1 to the devices respectively. Although it is referred to as the controller 400, this is an expression for being interpreted in a broad sense and is not limited thereto.

Furthermore, the input device 128 receives input of information on a destination and transmits information on the input destination to the AVN device 130 when a navigation function is selected and receives input of channel and volume information and transmit the input channel and volume information to the AVN device 130 when the DMB function is selected.

The center fascia 125 may be provided with the AVN device 130 that receives information from the user and outputs a result corresponding to the input information.

The AVN device 130 may perform at least one of navigation function, DMB function, audio function, and video function and may display environment information on roads, driving information, and the like in the autonomous driving mode.

The AVN device 130 may be disposed on the dashboard as a mounted-type.

A frame of the vehicle 1 further includes a power generation apparatus, a power transmission apparatus, a driving apparatus, a steering apparatus, a brake apparatus, a suspension apparatus, a transmission apparatus, a fuel supply apparatus, left/right front and rear wheels, and the like. The vehicle 1 may further be provided with various other safety apparatuses for the safety of the driver and passengers.

Examples of the safety apparatuses of the vehicle 1 include an airbag control apparatus configured for safety of the driver and passengers in a collision of the vehicle 1, an electronic stability control (ESC) apparatus to control a balance of the vehicle 1 during acceleration or cornering.

The vehicle 1 may further include detection apparatuses including a proximity detector to detect obstacles or another vehicle present beside and behind the vehicle 1, a rain detector to sense an event of rain and rainfall, a wheel speed detector to detect speeds of wheels, a lateral acceleration detector to detect lateral acceleration of the vehicle 1, a yaw rate detector to detect a change in the angular velocity of the vehicle 1, a gyro detector, and a steering angle detector to detect rotation of the steering wheel of the vehicle 1.

The vehicle 1 includes a power generation apparatus, a power transmission apparatus, a driving apparatus, a steering apparatus, a brake apparatus, a suspension apparatus, a transmission apparatus, a fuel supply apparatus, various safety apparatuses, and electronic control unit (ECU) to control the operation of various sensors.

Furthermore, the vehicle 1 may selectively include electronic apparatuses disposed for the convenience of the driver including a hands-free device, a GPS, an audio device, a Bluetooth device, a rear view camera, a charging device configured for a user terminal, a high pass device, and a speech recognition apparatus 100.

The vehicle 1 may further include a starter button to input a command to operate a starter motor. That is, when the starter button is turned on, the vehicle 1 operates the starter motor or and drives an engine which is a power generation apparatus via the operation of the starter motor.

The vehicle 1 may further include a battery electrically connected to a terminal device, an audio device, an internal light, a starter motor, and other electronic devices to supply driving power thereto. The battery performs charging by use of a self-power generator or power of the engine while driving.

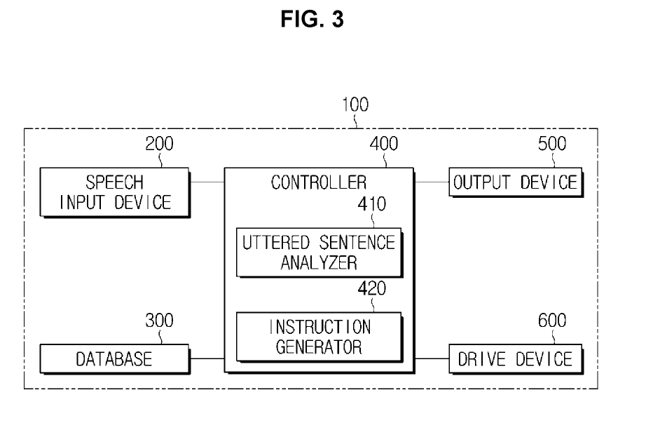

FIG. 3 is a control block diagram of the speech recognition apparatus 100.

Referring to FIG. 3, the speech recognition apparatus 100 includes a speech input device 200, a database 300, a controller 400, an output device 500, and a drive device 600.

The speech input device 200 is a device that receives a speech of the user. The speech input device 200 may be any device configured for recognizing a speech which is analog data and transmitting information on the speed. For example, the speech input device 200 may be implemented using a microphone. The speech input device 200 may be located at a dashboard or a steering wheel and may also be located at any position suitable for receiving the speech of the user without limitation.

The database 300 stores instruction codes used to generate instructions. The database 300 includes a target code corresponding to a target of control and a control command code corresponding to a control command. Furthermore, the database 300 includes a response message to an instruction and an inquiry about a predicted utterance.

In this regard, the target of control may be various devices or systems configured to implement functions of the vehicle 1. The speech recognition apparatus 100 according to an exemplary embodiment of the present invention may also be applied to operations of apparatuses or systems in various fields as well as the vehicle 1. Hereinafter, it is assumed that the speech recognition apparatus 100 is applied to the vehicle 1 for descriptive convenience.

The controller 400 converts a speech input via the speech input device 200 into speech data, analyzes a sentence uttered by the user included in the speech data after a predetermined waiting time, and generates an instruction corresponding an analyzed result. Furthermore, the controller 400 determines whether or not the uttered sentence includes a target of control and a control command. The controller 400 may be provided in the vehicle 1 or separately in the speech recognition apparatus 100.

The controller 400 separates the uttered sentence into morphemes and words, extracts a target of control and a control command from the uttered sentence separated into morphemes and words, and generates an instruction by combining a target code corresponding to the target of control and a control command code corresponding to the control command.

The controller 400 includes an uttered sentence analyzer 410 and an instruction generator 420.

The uttered sentence analyzer 410 separates the sentence uttered by the user into morphemes and words. A morpheme refers to the smallest element having a meaning in a language and a word refers to the minimum basic unit of language having a meaning and standing on its own or having a grammatical function in isolation.

For example, when an uttered sentence is ‘turn on the air conditioner’, the uttered sentence analyzer 410 separates the sentence into ‘turn/on/the/air conditioner’. The uttered sentence analyzer 410 extracts a target of control and a control command from the sentence separated into morphemes and words. Accordingly, ‘air conditioner’ is extracted as the target of control and ‘turn on’ is extracted as the control command.

The instruction generator 420 generates an instruction by combining a target code corresponding to the target of control and a control command code corresponding to the control command. The target code corresponding to the target of control ‘air conditioner’ is ‘aircon’ and the control command code corresponding to the control command ‘turn on’ is ‘on’. That is, the instruction is generated as ‘aircon on’.

The controller 400 transmits the instruction to the drive device 600 and the drive device 600 operates the target of control in accordance with the instruction.

The output device 500 outputs the analyzed sentence and a response message to the instruction. The output device 500 may be an audio output device or the display device of the AVN device 130. That is, the sentence uttered by the user and the response message corresponding thereto may be output to the display device of the AVN device 130. Also, the response message may be converted into a voice signal and output as a voice via the audio output device.

When no additional speech is input during a first waiting time after a speech of the user is input to the speech input device 200, the controller 400 analyzes a first uttered sentence included in speech data and generates an instruction corresponding to the first uttered sentence with reference to the database.

When the first uttered sentence includes both the target of control and the control command, the controller 400 determines that an instruction is completed and transmits the instruction to the drive device 600. When the first uttered sentence includes both the target of control and the control command, it may be determined that the instruction required to operate a function of the vehicle 1 is completed and thus there is no need to wait for an additional speech input of the user. That is, when the first uttered sentence includes both the target of control and the control command, the controller 400 generates a response immediately after the first waiting time, and thus a quick response may be provided.

On the other hand, when one or more of the target of control and the control command are not included in the first uttered sentence, the controller 400 waits to receive an additional speech input during a second waiting time. The speech input device 200 maintains an operating state thereof until an instruction is completed. For example, when the speech input device 200 is implemented using a microphone, the microphone maintains an On state until the instruction is completed.

When an additional speech is input within the second waiting time, the controller 400 re-analyzes the entire sentence including the first uttered sentence and a second uttered sentence included in additional speech data input after a time corresponding to the first waiting time elapses.

For example, the first uttered sentence may include only the target of control, and the second uttered sentence may include only the control command. Thus, there is a need to re-analyze the entire sentence including the first uttered sentence and the second uttered sentence to identify whether or not both the target of control and the control command are included therein.

When the additional speech input is not input during the second waiting time, the controller 400 generates an inquiry about a predicted utterance based on the first uttered sentence and a current state of the vehicle 1 and outputs the inquiry via the output device 500.

For example, the controller 400 generates an inquiry about the control command when the first uttered sentence includes only the target of control and generates an inquiry about the target of control when the first uttered sentence includes only the control command. Assuming that the air conditioner is currently turned on, when the first uttered sentence includes only ‘air conditioner’ which is a target of control, the controller 400 generates an inquiry ‘Would you like to turn off the air conditioner?’. When the first uttered sentence includes ‘turn off’ which is a control command, the inquiry ‘Would you like to turn off the air conditioner?’ may also be generated.

When the user responds to the inquiry, the controller 400 analyzes a response sentence uttered by the user, generates an instruction corresponding thereto, and transmits the instruction to the drive device 600 to finally control the target of control to operate.

As described above, a complete utterance of the user may be input by use of the speech recognition apparatus 100 according to an exemplary embodiment of the present invention by adjusting the waiting time for the input of the user's utterance even when an utterance speed of the user is relatively low.

Furthermore, malfunctions of the target of control may be reduced and a quicker response may be output by setting the first waiting time and the second waiting time, determining whether or not the instruction is completed via analysis of the utterance after the first waiting time, and generating a response or waiting for an additional utterance input during the second waiting time.

Also, since the speech recognition apparatus 100 according to an exemplary embodiment of the present invention generates an inquiry about a predicted utterance based on the current state of the vehicle 1, the inquiry may fit the intention of the user and the target of control may be driven according to the intention of the user.

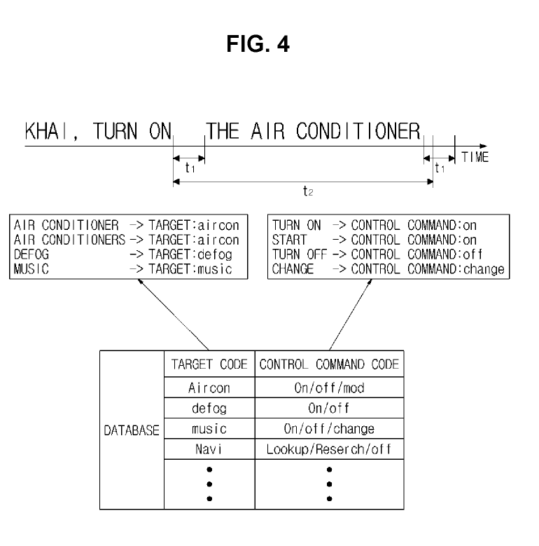

FIG. 4 is a diagram for describing a method of generating an instruction by analyzing an uttered sentence, the analyzing performed by a speech recognition apparatus according to an exemplary embodiment of the present invention.

Referring to FIG. 4, a case in which the user utters ‘Khai, turn on the air conditioner’ is exemplarily shown. When the user does not continuously utter ‘turn on the air conditioner’ but stops the utterance after ‘turn on’, the controller 400 does not immediately analyze the input sentence but waits for an additional speech input during a first waiting time t1.

When there is no additional input speech during the first waiting time t1 and at least one of the target of control and the control command is missing from the first uttered sentence, the controller 400 waits for an additional speech input during a second waiting time t2.

When ‘turn on’ is input during the second waiting time, the controller 400 analyzes the entire uttered sentence after a time corresponding to the first waiting time t1 elapses. In FIG. 4, the entire uttered sentence is ‘turn on the air conditioner’. Since the entire uttered sentence includes both the target of control and the control command, there are all elements required to generate an instruction.

In this regard, the first waiting time refers to a time period during which it may be determined that an utterance has ended. The first waiting time may be shorter than the second waiting time, and the first waiting time and the second waiting time may be pre-set and may be adjusted in accordance with user's settings.

As described above, the instruction is generated by combining the target code corresponding to the target of control and the control command code corresponding to the control command. The target of control included in the sentence uttered by the user may be called various names. For example, the user may utter ‘air-con, air conditioner, A/C, or the like’. Although the user utters different names, targets indicated are the same. Thus, one target code is assigned to the same target of control.

In the same manner, the control command may also be uttered with various names. For example, the user may utter ‘turn on, start, or the like’ and all correspond to the same control command to operate the target of control. Thus, one control command code is assigned to the same control command.

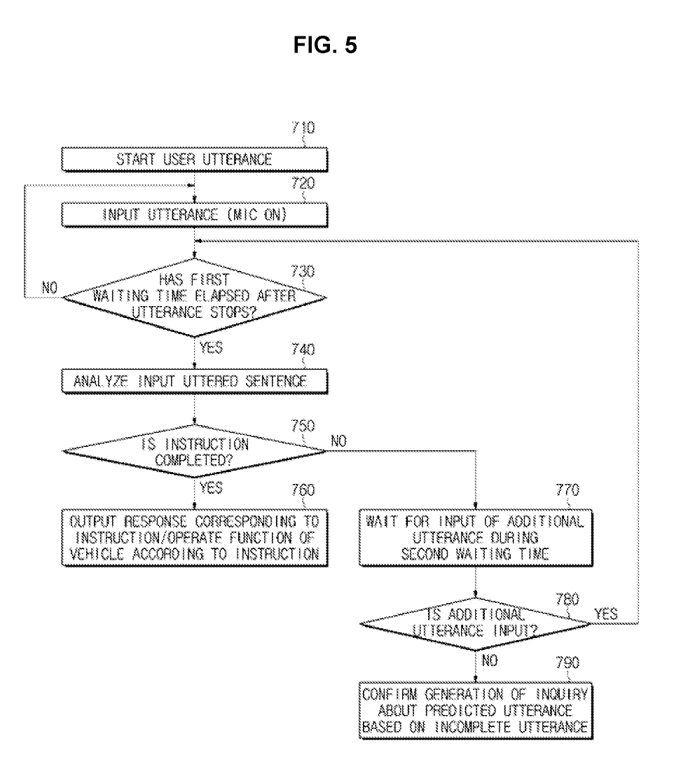

FIG. 5 is a flowchart of a method of controlling a speech recognition apparatus according to an exemplary embodiment of the present invention.

Referring to FIG. 5, when the user starts an utterance (710), the speech recognition apparatus 100 according to an exemplary embodiment of the present invention receives input of a speech of the user via the speech input device 200 (720). When the user's utterance stops, the controller 400 determines whether or not there is an additional speech input to the speech input device 200 during the first waiting time (730). When there is no additional input speech during the first waiting time, the controller 400 converts the input speech into speech data and analyzes an uttered sentence included in the speech data (740). When the user's utterance continues during the first waiting time, the speech input continues.

As such, the controller 400 determines whether or not the analyzed first uttered sentence includes both the target of control and the control command and determines an instruction generated based thereon is completed (750).

When the first uttered sentence includes both the target of control and the control command, the instruction is completed and thus the controller 400 outputs a response corresponding to the instruction via the output device 500 and transmits the instruction to the drive device 600 to control the target of control to operate (760).

When the first uttered sentence does not include one or more of the target of control and the control command, the instruction is not completed and thus the controller 400 waits for an additional speech input during the second waiting time (770).

The controller 400 determines whether or not an additional speech is input within the second waiting time (780). Upon determination that the additional speech is input, the controller 400 re-analyzes the entire uttered sentence including the first uttered sentence and the second uttered sentence included in additional speech data after a time corresponding to the first waiting time elapses.

When an additional speech is not input within the second waiting time, the controller 400 generates an inquiry about a predicted utterance based on the first uttered sentence and the current state of the vehicle (790).

The inquiry about a predicted utterance is generated with reference to the database 300. The controller 400 may generate an inquiry about a predicted utterance having the highest probability with reference to the database 300.

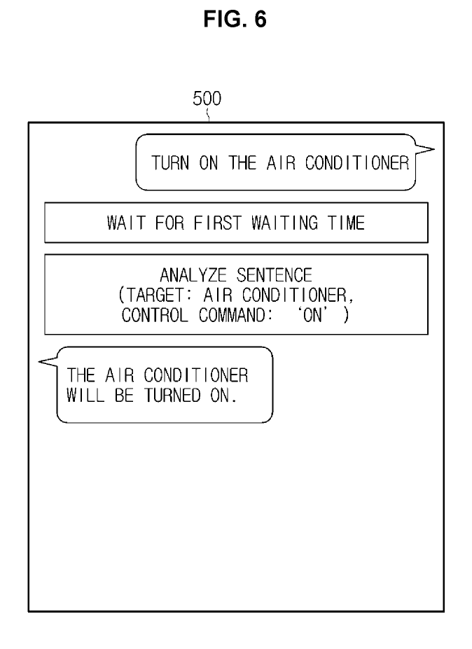

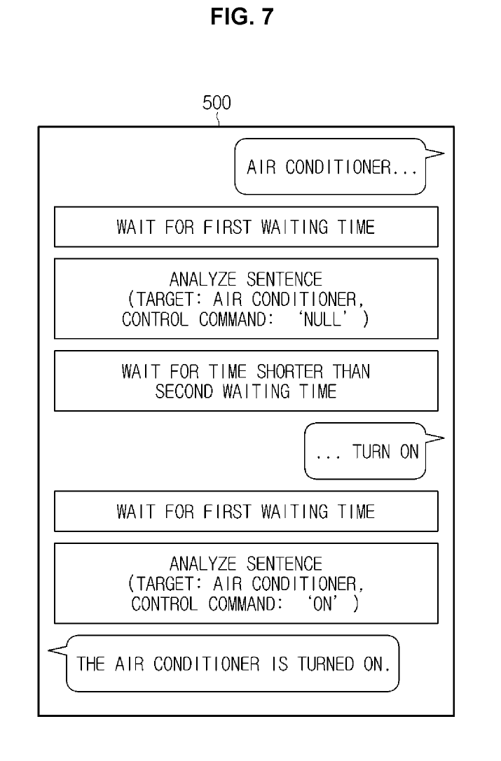

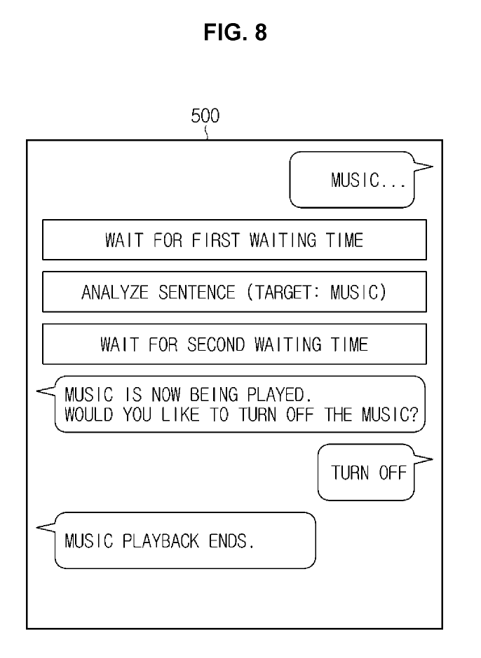

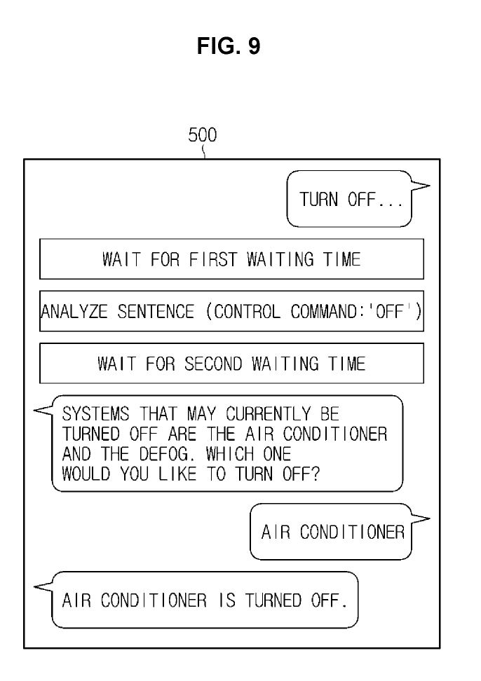

FIG. 6, FIG. 7, FIG. 8, and FIG. 9 are diagrams exemplarily illustrating output of response messages performed by the speech recognition apparatus 100 according to an exemplary embodiment.

Referring to FIG. 6, when the user utters ‘turn on the air conditioner’, the controller 400 waits for the first waiting time, analyzes the first uttered sentence ‘turn on the air conditioner’, and generates an instruction corresponding thereto. In this regard, the instruction is ‘aircon on’. Since the instruction is completed, the controller 400 operates the air conditioner by transmitting the instruction to the drive device 600. The output device 500 outputs the analyzed uttered sentence and a response message according to the instruction.

Referring to FIG. 7, when the user utters only ‘air conditioner’, the controller 400 extracts ‘air conditioner’ as a target of control and ‘aircon’ as a target code corresponding thereto by analyzing the sentence after the first waiting time to generate an instruction ‘aircon null’. In the instant case, since a control command is not input, the instruction is not completed. Thus, the controller 400 waits for an additional speech input during the second waiting time. When an additional speech ‘turn on’ is input, the controller 400 analyzes the entire uttered sentence after a time corresponding to the first waiting time elapses. In the instant case, there are both the target of control and the control command and thus the instruction is completed as ‘aircon on’. Since the instruction is completed, the controller 400 transmits the instruction to the drive device 600 to operate the air conditioner.

Referring to FIG. 8, when the first waiting time elapses after the user utters only ‘music’, and there is no additional speech input during the second waiting time, the controller 400 extracts ‘music’ as a target of control and ‘music’ as a target code corresponding thereto and generates an inquiry, e.g., ‘Music is currently being played. Would you like to turn off the music?’ by confirming the current state of the vehicle in which the music is being reproduced. The output device 500 outputs the generated inquiry. The controller 400 generates an instruction corresponding to ‘turn off’ uttered by the user in a response to the inquiry and transmits the instruction to the drive device 600 to turn off the music.

Referring to FIG. 9, when the first waiting time elapses after the user utters only ‘turn off’, and there is no additional speech input during the second waiting time, the controller 400 extracts ‘off’ as a control command and ‘off’ as a control command code corresponding thereto. The controller 400 identifies systems in which a control command ‘on’ may be executed among the systems currently turned ‘on’ in the vehicle and generates an inquiry ‘Systems that may currently be turned off are the air conditioner and the defog. Which one would you like to turn off?’. The controller 400 generates an instruction corresponding to ‘air conditioner’ uttered by the user in a response to the inquiry and transmits the instruction to the drive device 600 to turn off the air conditioner.

As described above, according to the method of controlling the speech recognition apparatus according to an exemplary embodiment of the present invention, malfunctions may be reduced and quicker responses may be output by setting the first waiting time and the second waiting time, determining whether or not the instruction is completed by analyzing the utterance after the first waiting time, and generating a response in accordance with the determination result or waiting for an additional utterance input during the second waiting time.

Furthermore, according to the method of controlling the speech recognition apparatus according to an exemplary embodiment of the present invention, the inquiry may fit the intention of the user and the target of control may be operated as desired by the user since the inquiry about the predicted utterance is generated based on the current state of the vehicle.

Meanwhile, the aforementioned embodiments may be embodied in a form of a recording medium storing instructions executable by a computer. The instructions may be stored in a form of program codes and perform the operation of the disclosed exemplary embodiments by creating a program module when executed by a processor. The recording medium may be embodied as a computer readable recording medium.

The computer readable recording medium includes all types of recording media that store instructions readable by a computer including read only memory (ROM), random access memory (RAM), magnetic tape, magnetic disc, flash memory, and optical data storage device.

As is apparent from the above description, according to the speech recognition apparatus and the method of controlling the same according to an exemplary embodiment of the present invention, a complete utterance of the user may be input by adjusting a waiting time for input of a user's utterance even when a user's speaking speed is relatively low.

According to the speech recognition apparatus and the method of controlling the same according to an exemplary embodiment of the present invention, malfunctions may be reduced and quicker responses may be output by setting the first waiting time and the second waiting time, determining whether or not the instruction is completed by analyzing the utterance after the first waiting time, and generating a response in accordance with the determination result or waiting for an additional utterance input during the second waiting time.

Furthermore, according to the method of controlling the speech recognition apparatus according to an exemplary embodiment of the present invention, the inquiry may fit the intention of the user and the target of control may be operated as desired by the user since the inquiry about the predicted utterance is generated based on the current state of the vehicle.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A speech recognition apparatus comprising:
a speech input device configured to receive input of a speech of a user;
a database configured to store instruction codes used to generate an instruction;
a controller configured to convert the speech into speech data, analyze a sentence uttered by the user included in the speech data after a predetermined waiting time, generate an instruction corresponding to an analyzed uttered sentence, and determine whether the uttered sentence includes a target of control and a control command;
an output device configured to output the analyzed uttered sentence and a response message to the instruction; and
a drive device configured to operate the target of control in accordance with the instruction.

2. The speech recognition apparatus of claim 1, wherein, when an additional speech is not input during a first waiting time, the controller is configured to analyze a first uttered sentence included in the speech data and to generate an instruction corresponding to the first uttered sentence with reference to the database.

3. The speech recognition apparatus of claim 2, wherein, when the first uttered sentence includes the target of control and the control command, the controller is configured to determine that the instruction is completed and to transmit the instruction to the drive device.

4. The speech recognition apparatus of claim 2, wherein, when the first uttered sentence does not include one or more of the target of control and the control command, the controller is configured to receive input of an additional speech during a second waiting time.

5. The speech recognition apparatus of claim 4, wherein, when the additional speech is input during the second waiting time, the controller re-analyzes an entire uttered sentence including the first uttered sentence and a second uttered sentence included in additional speech data after a time corresponding to the first waiting time elapses.

6. The speech recognition apparatus of claim 4, wherein, when the additional speech is not input during the second waiting time, the controller is configured to generate an inquiry about a predicted utterance based on the first uttered sentence and a current state of a vehicle.

7. The speech recognition apparatus of claim 6, wherein the controller is configured to analyze a sentence uttered by the user in a response to the inquiry about the predicted utterance, to generate an instruction corresponding to an analyzed uttered sentence, and to transmit the instruction to the drive device.

8. The speech recognition apparatus of claim 1, wherein the controller is configured to separate the uttered sentence into morphemes and words, extracts a target of control and a control command from the uttered sentence separated into morphemes and words, and generates the instruction by combining a target code corresponding to the target of control and a control command code corresponding to the control command.

9. The speech recognition apparatus of claim 8, wherein the database includes the target code corresponding to the target of control and the control command code corresponding to the control command.

10. The speech recognition apparatus of claim 1, wherein the database includes a target code corresponding to the target of control, a control command code corresponding to the control command, a response message to the instruction, and an inquiry about a predicted utterance.

11. A method of controlling a speech recognition apparatus, the method comprising:
receiving input of a speech of a user;
generating an instruction by converting the speech into speech data, and analyzing a sentence uttered by the user included in the speech data after a predetermined waiting time;
determining whether the uttered sentence includes a target of control and a control command;
outputting the analyzed uttered sentence and a response message in accordance with the instruction; and
operating the target of control according to the instruction.

12. The method of claim 11, wherein the generating of the instruction further includes:
analyzing a first uttered sentence included in the speech data when an additional speech is not input during a first waiting time; and
generating an instruction corresponding to the first uttered sentence with reference to a database.

13. The method of claim 12, wherein the operating of the target of control is performed by operating the target of control in accordance with the instruction when the first uttered sentence includes the target of control and the control command.

14. The method of claim 12, wherein the receiving of input of a speech of a user further includes receiving input of an additional speech during a second waiting time when the first uttered sentence does not include one or more of the target of control and the control command.

15. The method of claim 14, wherein the generating of the instruction further includes re-analyzing an entire uttered sentence including the first uttered sentence and a second uttered sentence included in additional speech data after a time corresponding to the first waiting time elapses when the additional speech is input during the second waiting time.

16. The method of claim 14, wherein the generating of the instruction further includes generating an inquiry about a predicted utterance based on the first uttered sentence and a current state of a vehicle when the additional speech is not input during the second waiting time.

17. The method of claim 16, wherein the generating of the instruction further includes analyzing a sentence uttered by the user in a response to the inquiry about the predicted utterance and generating an instruction corresponding to the analyzed uttered sentence.

18. The method of claim 11, wherein the generating of the instruction is performed by separating the uttered sentence into morphemes and words, extracting the target of control and the control command from the uttered sentence separated into the morphemes and the words, and generating an instruction by combining a target code corresponding to the target of control and a control command code corresponding to the control command.

19. The method of claim 12, wherein the database includes a target code corresponding to the target of control, a control command code corresponding to the control command, a response message to the instruction, and an inquiry about a predicted utterance.
